(19) United States
(12) Patent Application Publication
(10) Pub. No.: US 2019/0056684 A1
(43) Pub. Date: Feb. 21, 2019

(54) FIXING DEVICE AND IMAGE FORMING APPARATUS

(71) Applicant: KYOCERA Document Solutions Inc., Osaka (JP)

(72) Inventors: Takashi EIKI, Osaka-shi (JP); Hiroki KAWASAKI, Osaka-shi (JP); Ryohei TOKUNAGA, Osaka-shi (JP); Atsushi KOHAMA, Osaka-shi (JP); Yuhiro SAKAI, Osaka-shi (JP); Kotatsu KAWAGUCHI, Osaka-shi (JP)

(73) Assignee: KYOCERA Document Solutions Inc., Osaka (JP)

(21) Appl. No.: 16/101,111

(22) Filed: Aug. 10, 2018

(30) Foreign Application Priority Data
Aug. 18, 2017 (JP) 2017-157841

(51) Int. Cl. G03G 15/20; G03G 15/06; G03G 15/00

(52) U.S. Cl. CPC G03G 15/2053; G03G 15/757; G03G 15/206; G03G 15/065

(57) ABSTRACT

The fixing device includes a fixing member, a pressing member, and a heat source. The fixing member heats toner on a medium. The pressing member forms a pressing area with the fixing member and presses the toner. The heat source is provided corresponding to the pressing area across the fixing member and heats the fixing member. The heat source includes a heat insulation layer and a heating and contacting part. The heat insulation layer is laminated on a base material and has a convex part that protrudes toward the fixing member. The heating and contacting part is laminated on the heat insulation layer that has the convex part and contacts to an inner surface of the fixing member so as to heat the fixing member. The convex part protrudes the heating and contacting part laminated thereon toward the fixing member so as to maximize pressure in the pressing area.

### INCORPORATION BY REFERENCE

This application is based on and claims the benefit of priority from Japanese Patent application No. 2017-157841 filed on Aug. 18, 2017; the entire contents of which are incorporated herein by reference.

### BACKGROUND

The present disclosure relates to a fixing device and an image forming apparatus.

An electrographic image forming apparatus includes a fixing device that fixes toner on a medium.

For example, the fixing device that includes a heating member, a resin holder, a fixing film, and an elastic roller is proposed. The heating member has a heating resistance layer on a circuit board. The resin holder holds the heating member. The fixing film moves with contacting to the heating member and the holder. The elastic roller forms a nip part via the fixing film with the heating member and the holder. Intrusion amount of the heating member against the elastic roller gradually increases from an upstream side toward a downstream side in a direction through which a recording material passes. Pressure of the nip part becomes a maximum peak at a portion of the holder neighboring to a downstream end of the heating member. The heating member does not exist in the downstream side of the maximum peak in the direction through which the recording material passes, and the nip part is formed by the holder and the elastic roller. In this fixing device, there is no area in which the pressure decreases toward the maximum peak of the pressure in the nip part, which can reduce gloss unevenness of an output image.

### SUMMARY

In accordance with an aspect of the present disclosure, a fixing device includes a fixing member, a pressing member, and a heat source. The fixing member heats toner on a medium with rotating around an axis thereof. The pressing member, with rotating around an axis thereof, forms a pressing area with the fixing member and presses the toner on the medium passing through the pressing area. The heat source is provided corresponding to the pressing area across the fixing member and heats the fixing member. The heat source includes a heat insulation layer and a heating and contacting part. The heat insulation layer is laminated on a base material and has a convex part that protrudes toward the fixing member. The heating and contacting part is laminated on the heat insulation layer that has the convex part and contacts to an inner surface of the fixing member so as to heat the fixing member. The convex part protrudes the heating and contacting part laminated thereon toward the fixing member so as to maximize pressure in the pressing area.

In accordance with an aspect of the present disclosure, an image forming apparatus includes the aforementioned fixing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view (a front view) that shows a printer in accordance with one embodiment of the present disclosure.

FIG. 2 is a sectional view that schematically shows a fixing device in accordance with one embodiment of the present disclosure.

FIG. 3 is a bottom view that schematically shows a heater in accordance with one embodiment of the present disclosure.

FIG. 4 is a sectional view along a line IV-IV of FIG. 3.

FIG. 5 is a graph that shows a change in dynamic viscoelasticity of toner and glossiness of an image.

FIG. 6 is a graph that shows a change in pressure of a pressing area and dynamic viscoelasticity of toner in the fixing device in accordance with one embodiment of the present disclosure.

FIG. 7 is a graph that shows a change in pressure of a pressing area and dynamic viscoelasticity of toner in the fixing device in accordance with another example of one embodiment of the present disclosure.

FIG. 8 is a sectional view that schematically shows a heater of a fixing device in accordance with another example of one embodiment of the present disclosure.

### DETAILED DESCRIPTION

Hereinafter, an embodiment of the present disclosure will be explained with reference to attached figures. Arrows “Fr”, “Rr”, “L”, “R”, “U”, and “D” shown in the figures respectively indicate a front side, a rear side, a left side, a right side, an upside, and a downside.

<<Overall Configuration of a Printer >>

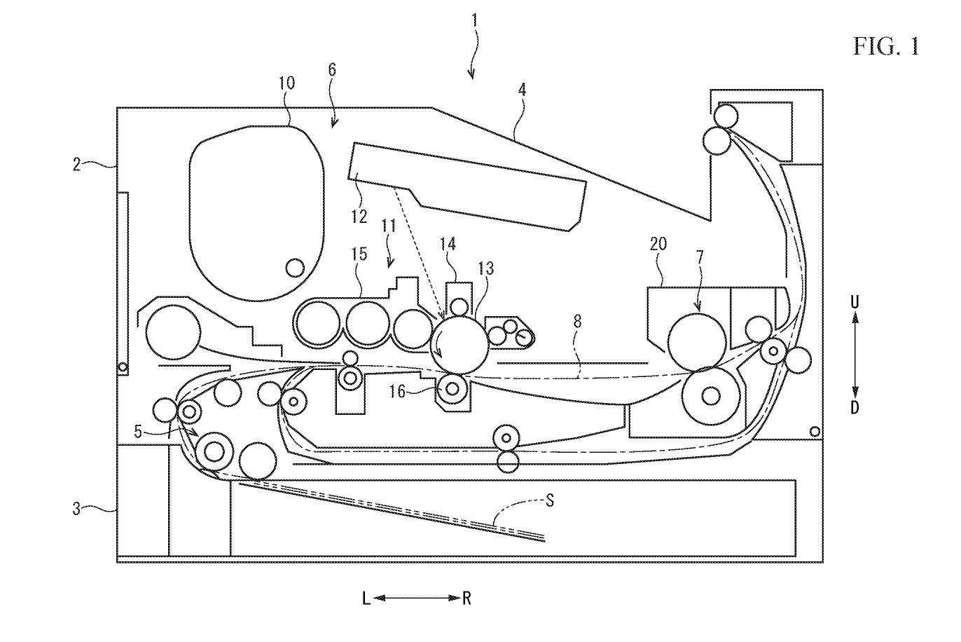

With reference to FIG. 1, a printer 1 as an example of an image forming apparatus will be described. FIG. 1 is a schematic view (front view) that shows the printer 1.

The printer 1 includes main body 2 configuring a substantially rectangular parallelepiped-appearance. In a lower part of the main body 2, a sheet feeding cartridge 3 storing sheets S (media) such as plain papers is provided. In an upper surface of the main body 2, a sheet ejecting tray 4 is provided. The sheet S is not limited to the paper sheet and can be a resin sheet or the like.

The printer 1 includes a sheet feeding device 5, an imaging device 6, and a fixing device 7. The sheet feeding device 5 is provided at an upstream end of a conveying path 8 extending from the sheet feeding cartridge 3 to the sheet ejecting tray 4. The imaging device 6 is provided at an intermediate part of the conveying path 8, and the fixing device 7 is provided at a downstream side of the conveying path 8.

The imaging device 6 includes a toner container 10, a drum unit 11, and an optical scanning device 12. The toner container 10 contains, for example, black toner (developer). The drum unit 11 includes a photosensitive drum 13, a charger 14, a development device 15, and a transfer roller 16. The transfer roller 16 is in contact with a downside of the photosensitive drum 13 so as to form a transferring nip. The toner may be two-component developer obtained by mixing toner and carrier, or may be one-component developer composed of magnetic toner.

A control device (not shown) of the printer 1 appropriately controls so as to execute image forming process as follows. The charger 14 charges a surface of the photosensitive drum 13. The photosensitive drum 13 receives a scanning light emitted from the optical scanning device 12 and carries an electrostatic latent image. The development device 15 develops the electrostatic latent image on the photosensitive drum 13 to form a toner image using the toner supplied from the toner container 10. The sheet S is fed out by the sheet feeding device 5 from the sheet feeding cartridge 3 to the conveying path 8. The toner image having been formed on the photosensitive drum 13 is transferred to the sheet S passing through the transferring nip. The fixing device 7 thermally fixes the toner image on the sheet S. Afterward, the sheet S is ejected to the sheet ejecting tray 4.

<<Fixing Device>>

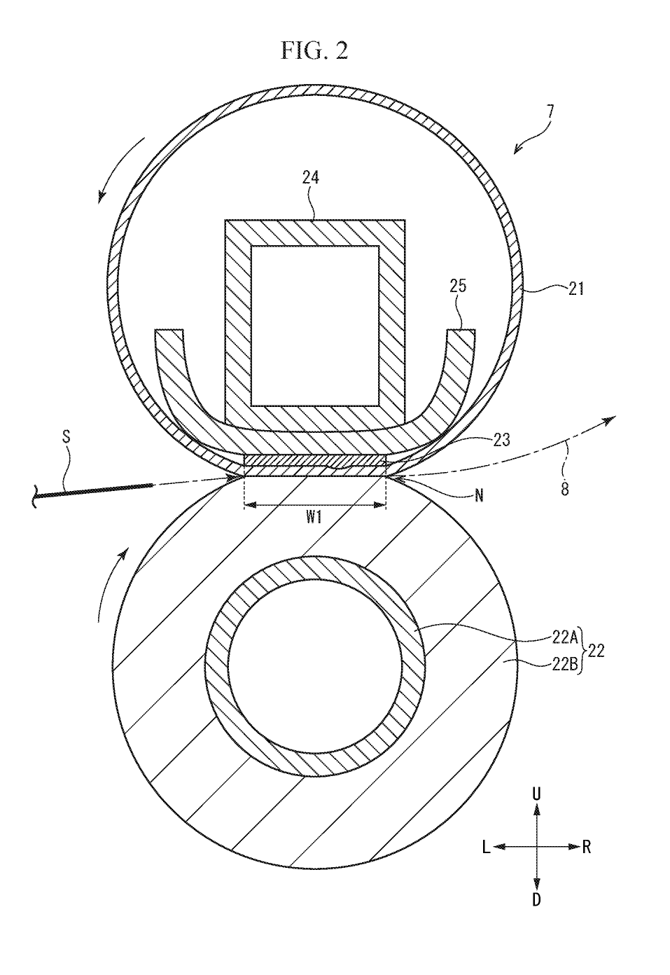

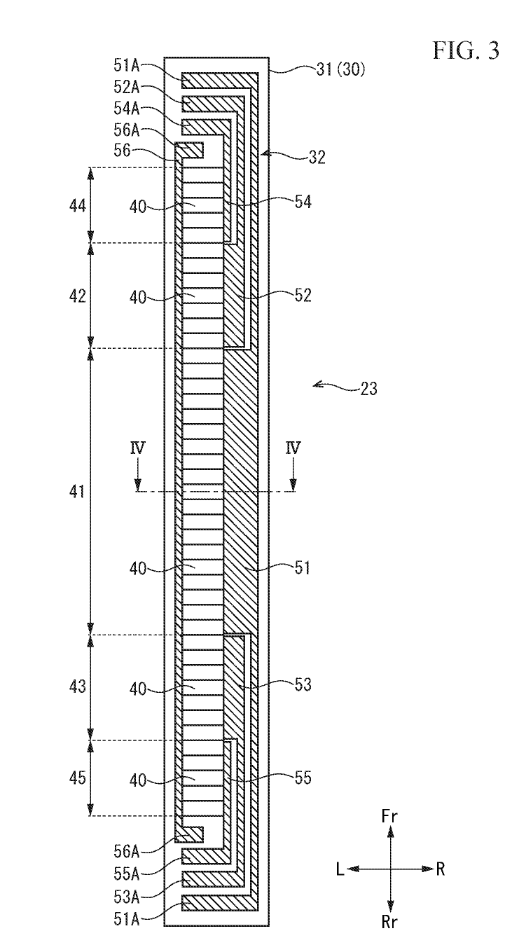

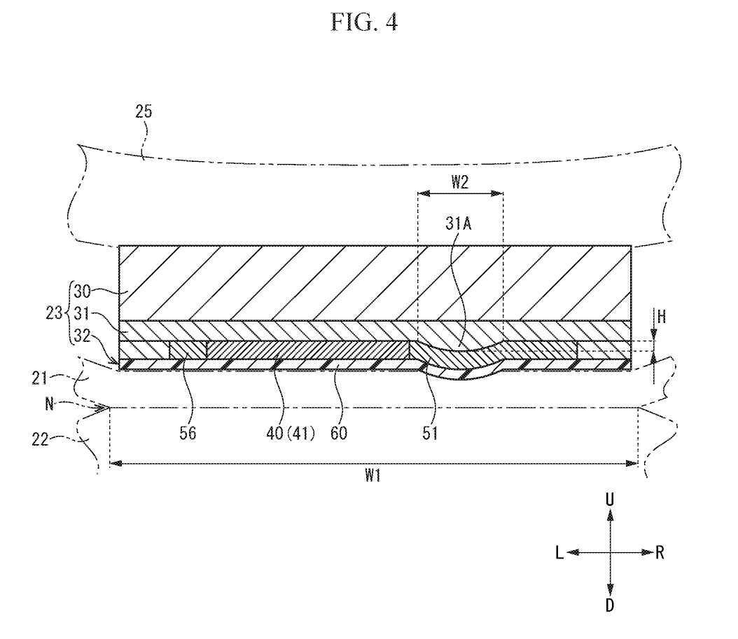

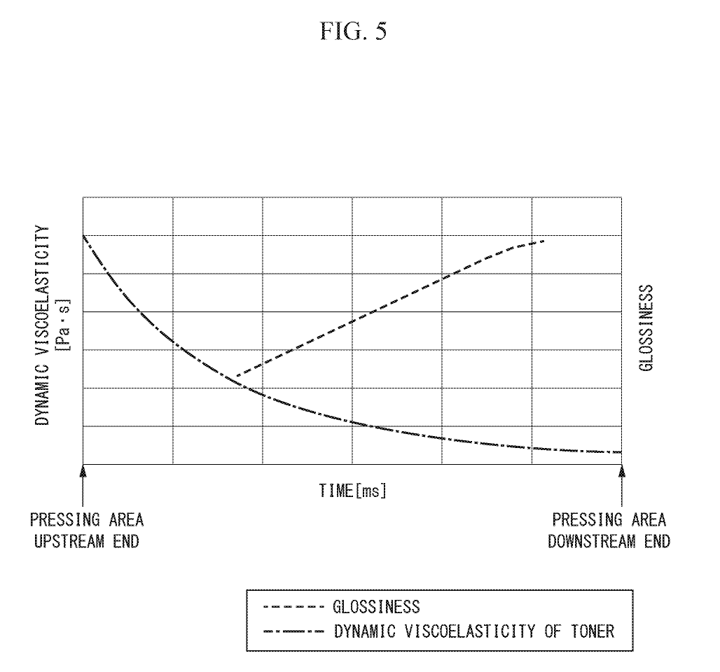

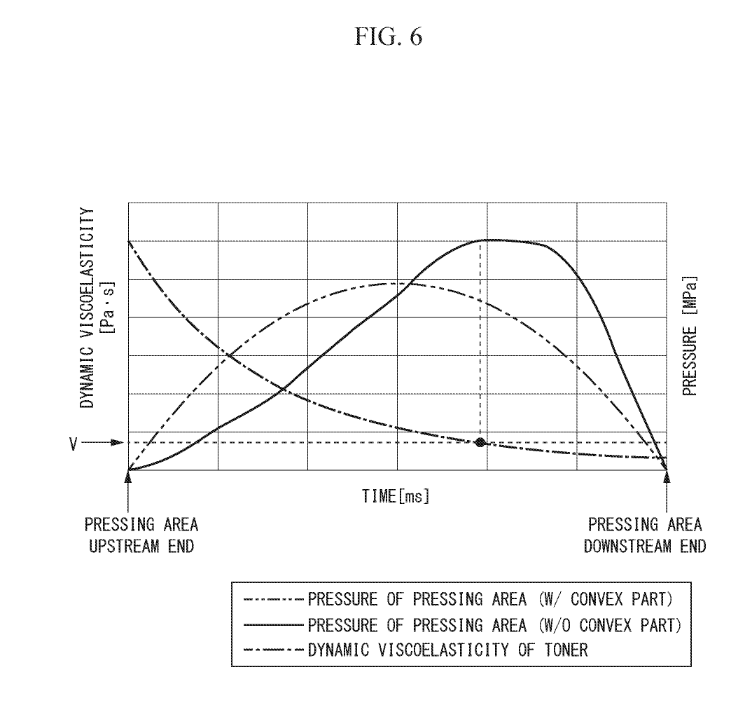

Subsequently, the fixing device 7 will be explained with reference to FIGS. 2 to 6. FIG. 2 is a sectional view that schematically shows the fixing device 7. FIG. 3 is a bottom view that schematically shows a heater 23. FIG. 4 is a sectional view along a line IV-IV of FIG. 3. FIG. 5 is a graph that shows a change in dynamic viscoelasticity of toner and glossiness of an image. FIG. 6 is a graph that shows a change in pressure of a pressing area N and dynamic viscoelasticity of toner in the fixing device in accordance with one embodiment of the present disclosure. Hereinafter, a “passing direction” (or a “medium passing direction”) indicates a direction that is a direction in which the sheet S passes (i.e., is conveyed) through a pressing area N (described later) of the fixing device 7. In addition, “upstream” and “downstream”, and expressions being similar thereto respectively indicate “upstream” and “downstream” in the passing direction, and similar notions.

As shown in FIG. 2, the fixing device 7 includes a fixing belt 21, a pressing roller 22, and a heater 23. The fixing belt 21 and the pressing roller 22 are provided in a housing 20 (cf. FIG. 1). The heater 23 is a heat source that heats the fixing belt 21.

<Fixing Belt>

The fixing belt 21, which is an example of a fixing member, is an endless belt that is a substantially cylindrical member being elongated in a front-back direction (i.e., an axial direction). For instance, a surface of the fixing belt 21 is made of a synthetic resin material that has heat resistance property and elasticity, such as a polyimide resin. The fixing belt 21 is located in an upper part of the housing 20. A pair of substantially cylindrical caps (not shown) are fitted at both ends in the axial direction of the fixing belt 21. A belt guide (not shown) that retains a substantially cylindrical form of the fixing belt 21 may be provided in the fixing belt 21.

A pressing member 24 is provided in the fixing belt 21. For instance, the pressing member 24 is made of a metallic material and is a substantially rectangular cylindrical member being elongated in the axial direction. The pressing member 24 passes through the fixing belt 21 (and the caps) in the axial direction and is supported by the housing 20. The above-described fixing belt 21 is supported rotatably with respect to the pressing member 24.

<Pressing Roller>

The pressing roller 22, which is an example of a pressing member, is a substantially cylindrical member being elongated in the front-back direction (i.e., the axial direction). The pressing roller 22 is located in a down part of the housing 20. The pressing roller 22 includes a metallic core metal 22A and an elastic layer 22b, such as a silicone sponge, that is laminated on an outer peripheral surface of the core metal 22A. Both ends in the axial direction of the core metal 22A are rotatably supported by the housing 20. A driving motor (not shown) is connected to the core metal 22A via a gear train or the like. The pressing roller 22 is rotationally driven by the driving motor. The fixing device 7 includes a pressure adjusting part (not shown) that raises and lowers the pressing roller 22 so as to adjust contact pressure of the pressing roller 22 against the fixing belt 21. Pressing the pressing roller 22 against the fixing belt 21 causes to form a pressing area N between the fixing belt 21 and the pressing roller 22. The pressing area N is a region from a position upstream in which the pressure is 0 Pa to a position downstream in which the pressure returns to 0 Pa after passing through a position in which the pressure becomes a maximum.

<Heater>

The heater 23, which is an example of a heat source, is a substantially rectangular plate shape member being elongated in the front-back direction (i.e., the axial direction). (cf. FIG. 3) The heater 23 is fixed beneath the pressing member 24 via a supporting member 25. For instance, the supporting member 25 is made of a heat resistant resin material and is a substantially half-cylindrical member being elongated in the axial direction. The supporting member 25 is incurvated along a lower inner surface of the fixing belt 21.

As shown in FIGS. 3 and 4, the heater 23 includes a base material 30, a heat insulation layer 31, and a heating and contacting part 32. The base material 30 is fixed on a lower surface of the supporting member 25. The heating and contacting part 32 is formed via the heat insulation layer 31 on the base material 30.

As shown in FIG. 4, the heater 23 is held beneath the supporting member 25 in which the heating and contacting part 32 is directed to the pressing roller 22 and the heating and contacting part 32 contacts to an inner surface of the fixing belt 21. The heater 23 supports the fixing belt 21 that is pressed by the pressing roller 22, so that the pressing area N is formed at a contacting part of the fixing belt 21 and the pressing roller 22. The heater 23 is provided corresponding to the pressing area N across the fixing belt 21 (see also FIG. 2), and has a function of heating the fixing belt 21. Besides, a temperature sensor (not shown) that detects surface temperature of the fixing belt 21 and/or temperature of the heater 23 is provided in the housing 20.

As shown in FIGS. 3 and 4, for instance, the base material 30 is made of a material that has electrical insulating property, such as a ceramic, and is a substantially rectangular plate shape member being elongated in the axial direction. Both upper and lower surfaces of the base material 30 is formed substantially flat and smooth.

The heat insulation layer 31 is laminated (formed) on one surface (all of a lower surface) of the base material 30. For instance, the heat insulation layer 31 is made of a material that has electrical insulating property and low thermal conductivity λ (e.g., λ≤10 W·m⁻¹·K⁻¹), such as a ceramic (a glass), and is formed on the base material. The heat insulation layer 31 has a function of restricting that heat generated at the heating and contacting part 32 is transferred to a side of the base material 30.

As shown in FIG. 4, the heat insulation layer 31 includes a convex part 31A that protrudes toward the fixing belt 21 (i.e., protrudes downward). The convex part 31A upheaves from a surface (i.e., a bottom surface) and is a substantially half-cylindrical member being elongated in the front-back direction. The convex part 31A is formed to be elongated over a substantially entire area in the front-back direction on the surface of the heat insulation layer 31. The convex part 31A is formed on a downstream side of a center in the passing direction of the heat insulation layer 31. For instance, a protruding amount H of the convex part 31A (i.e., a height from the surface of the heat insulation layer 31 to a top of the convex part 31A) is set to approximately 0.3 mm. For example, a length in the passing direction of the convex part 31A (i.e., an upheaval width W2) is set to approximately 16 percent of a length in the passing direction of the pressing area N (i.e., a pressurization width W1). The protruding amount H is not limited to the above exemplification and may be set equal to or higher than 0.1 mm and equal to or less than 1.0 mm. The length in the passing direction of the convex part 31A (i.e., the upheaval width W2) is not limited to the above exemplification and may be set equal to or higher than 15 percent and equal to or less than 20 percent of the length in the passing direction of the pressing area N (i.e., the pressurization width W1).

As shown in FIGS. 3 and 4, the heating and contacting part 32 is laminated on one surface (a lower surface) of the heat insulation layer 31 that includes the convex part 31A. The heating and contacting part 32 includes plural (e.g., five) heating parts 41 to 45, plural (e.g., six) electrode parts 51 to 56, and a coat layer 60.

For instance, the heating parts 41 to 45 are made of a material (such as a metal) that has electrical conductivity with resistance value that is higher than that of the electrode parts 51 to 56, and are formed on a lower surface of the heat insulation layer 31. As shown in FIG. 3, the heating parts 41 to 45 are arranged in a line in the axial direction. Each of the heating parts 41 to 45 is formed of heating resistors 40 that are arranged in line in the axial direction. Each of the heating resistors 40 is formed so as to be substantially rectangularly elongated in the passing direction. All of the heating resistors 40 are formed in substantially the same dimensions.

The heating part 41 that is located at a center in the axial direction is formed of heating resistors 40 that are arranged in a range corresponding to a front-to-rear width of a small size (e.g., A5 size) sheet S that passes through the pressing area N. The heating parts 42 and 43 that are located on both sides in the axial direction of the heating part 41 are formed of heating resistors 40 that are arranged in a range corresponding to a front-to-rear width of a middle size (e.g., B5 size) sheet S that passes through the pressing area N. The heating parts 44 and 45 that are located on both sides in the axial direction of the heating parts 42 and 43 are formed of heating resistors 40 that are arranged in a range corresponding to a front-to-rear width of a normal size (e.g., A4 size) sheet S that passes through the pressing area N.

For instance, the electrode parts 51 to 56 are made of a material (such as a metal) that has electrical conductivity with resistance value that is lower than that of the heating resistors 40, and are formed on the heat insulation layer 31. The electrode parts 51 to 56 are electrically connected to both sides in the passing direction of the heating parts 41 to 45. In detail, the electrode part 51 is connected to downstream ends (i.e., right ends) of the heating resistors 40 that form the heating part 41 in the center in the axial direction. In an analogous fashion, the other electrode parts 52 to 55 are each connected to downstream ends of the heating resistors 40 that form the respective heating parts 42 to 45. On the other hand, the electrode part 56 is connected to upstream ends in the passing direction (i.e., left ends) of all of the heating resistors 40. The electrode parts 51 to 56 respectively include electrode terminal parts 51A to 56A at tip parts that respectively extend from portions connected to the heating parts 41 to 45 to positions outside the heating parts 41 to 45 in the axial direction.

As shown in FIG. 4, the coat layer 60 coats the heating parts 41 to 45 and the electrode parts 51 to 56. For instance, the coat layer 60 is made of a material that has electrical insulating property and relatively small sliding friction force (e.g., μ≤0.1) against the fixing belt 21, such as a ceramic. The coat layer 60 forms a surface that contacts to the inner surface of the fixing belt 21. Materials that have electrical insulating property such as the heat insulation layer 31 and the coat layer 60 are laminated on portions on which the heating parts 41 to 45 or the electrode parts 51 to 56 are laminated.

In order to manufacture the above-described heater 23, for instance, a film forming technology such as sputtering, a production technology of a printed-circuit board, or a screen printing technology, or any combination of these technologies can be used. For example, the heat insulation layer 31 (the convex part 31A) and the heating and contacting part 32 (the heating parts 41 to 45, the electrode parts 51 to 56, the coat layer 60) may be laminated on the base material 30 using the sputtering technology. In the sputtering technology, thickness of a film layer can be adjusted in a micrometer order, the convex part 31A can be formed on the heat insulation layer 31 with high dimensional accuracy. Alternatively, the heat insulation layer 31 and the heating and contacting part 32 may be formed on the base material 30 by repeating processes of exposure, development, etching, delamination, lamination and so forth, using photolithographic masks used as the production technology of the printed-circuit board. The heat insulation layer 31 and the heating and contacting part 32 may be formed by applying (i.e., screen-printing) electrical insulation paint or electrically conductive paint to the base material 30. By using these manufacturing processes, the convex part 31A can also be accurately formed on the heat insulation layer 31 in common with the sputtering technology. In any production technologies, the heating parts 41 to 45 (the heating resistors 40) are formed in substantially the same layer height (i.e., with substantially the same thickness of the film layers). The same is true of the electrode parts 51 to 56 and the coat layer 60.

In the heater 23 that is manufactured as stated above, the heating and contacting part 32 (including the heating parts 41 to 45, the electrode parts 51 to 56, and the coat layer 60) is formed on the convex part 31A, so that the convex part 31A protrudes the laminated heating and contacting part 32 toward the fixing belt 21 (the pressing area N) (cf. FIG. 4). In consequence, a position in which the convex part 31A is formed is most protruding in the pressing area N and generates an area with the highest pressure in the pressing area N. That is, the convex part 31A has a function to maximize the pressure in the pressing area N.

The electrode parts 51 to 56, the driving motor and so forth of the heater 23 are electrically connected via various driving circuits (not shown) to a power source (not shown). The heater 23 (the electrode parts 51 to 56), the driving motor, the temperature sensor and so forth are electrically connected via various circuits to a control device of the printer 1. The control device controls devices or the like being connected thereto.

<<Operation of the Fixing Device>>

Hereinafter, operation of the fixing device 7 (i.e., fixing processing) will be explained mainly referring to FIG. 2.

The control device executes driving control of the driving motor and the heater 23. The pressing roller 22 is rotated by driving force of the driving motor, and the fixing belt 21 is rotated by following the pressing roller 22 (cf. solid lines in FIG. 2). The heating resistors 40 (cf. FIG. 3) of the heating parts 41 to 50 are heated by applying electrical current (i.e., by being fed with power) in the passing direction between the electrode parts 51 to 56 sandwiching the heating parts 41 to 45, which causes the fixing belt 21 to be heated.

In the above heating process, the control device changes the heating parts 41 to 45 (cf. FIG. 3) to be heated in accordance with a size of the sheet S. For instance, when a normal size of the sheet S passes through the pressing area N, the control device supplies all of the heating parts 41 to 45 with electrical power so as to heat all of the heating parts 41 to 45. Or, for instance, the control device heats the heating parts 41 to 43 when a middle size of the sheet S passes through the pressing area N, and heats the heating part 41 when a small size of the sheet S passes through the pressing area N. Thereby, a necessary portion of the fixing belt 21 (or the pressing area N) can be heated in accordance with the size of the sheet S. As a result, excessive temperature rise of both ends in the axial direction of the fixing belt 21 can be restrained.

The temperature sensor detects surface temperature of the fixing belt 21 and transmits a detection signal via an input circuit to the control device. When receiving a detection signal indicating that a preset temperature (e.g., 150 to 200 degrees Celsius) is attained from the temperature sensor, the control device starts to execute the above-explained image forming process with controlling the heater 23 so as to maintain the preset temperature. The sheet S on which the toner image is transferred enters the housing 20, then the fixing belt 21 heats the toner (i.e., the toner image) on the sheet S that passes through the pressing area N with normally rotating around the axis. The pressing roller 22 presses the toner on the sheet S that passes through the pressing area N with rotating around the axis. As a result, the toner image is fixed on the sheet S. Then the sheet S on which the toner image is fixed is sent out of the housing 20 to be ejected to the sheet ejecting tray 4.

In the foregoing fixing device 7, the toner (i.e., the toner image) on the sheet S is heated with being pressed, melts to be affinitive to the sheet S, and then fixes on the sheet S. As shown in FIG. 5, when the toner starts to melts in a process in which the sheet S passes through the pressing area N, dynamic viscoelasticity starts to decrease. It is known that glossiness of an image increases by imposing large pressure against the toner with the dynamic viscoelasticity being sufficiently decreased. Consequently, in the fixing device 7 in accordance with the present embodiment, the convex part 31A that maximizes the pressure in the pressing area N is formed on the heat insulation layer 31 and in a section in which the dynamic viscoelasticity of the toner on the sheet S decreases while the sheet S passes through the pressing area N.

Here, for instance, a case in which the dynamic viscoelasticity of the toner varies as indicated in FIG. 6 using a dashed and single-dotted line while the toner on the sheet S passes through the pressing area N will be considered.

As shown in FIG. 6, the dynamic viscoelasticity of the toner acutely decreases in a section from an upstream end of the pressing area N to an approximately intermediate position in the passing direction of the pressing area N. The dynamic viscoelasticity of the toner gradually decreases after the sheet S passes through the approximately intermediate position in the passing direction of the pressing area N. That is, fluctuation of the dynamic viscoelasticity of the toner becomes reduced in a section from the approximately intermediate position in the passing direction of the pressing area N to a downstream end of the pressing area N. The pressure of the pressing area N becomes the maximum in the section in which the dynamic viscoelasticity of the toner gradually decreases, which causes the toner being tightly fixed on the sheet S and brings an image having high glossiness. In other words, image quality can be stabilized by the above-described measures.

The dynamic viscoelasticity of the toner in which the image quality is stabilized (also stated as “a set value V” hereinafter) may differ depending on various factors, such as the pressurization width W1 in the passing direction of the pressing area N, the pressure of the pressing area N, a temperature of the pressing area N, a melting temperature of the toner, and so forth. The set value V in the fixing device 7 in accordance with the present embodiment is set in accordance with following bases. For instance, the set value V is set so that a storage elastic modulus G′ (an elastic component) of the toner is equal to or less than 4200 Pa and a loss elastic modulus G″ (a viscosity component) of the toner is equal to or less than 60000 Pa. The storage elastic modulus G′ and the loss elastic modulus G″ can be measured by using a rheometer (e.g., MCR-301 manufactured by Anton Paar GmbH). In the present embodiment, as an example of measuring the dynamic viscoelasticity, the storage elastic modulus G′ and the loss elastic modulus G″ are measured using the above rheometer in a condition of frequency of 10 Hz, temperature rising rate of 4° C./min, measurement temperature from 40 to 200° C., and strain 1%. The temperature of the pressing area N is recognized by measuring temperatures of the upstream and downstream sides (i.e., the entry and exit sides) of the pressing area N, and the temperature in which the above-described dynamic viscoelasticity characteristics can be obtained.

The convex part 31A is formed at a position between the center and the downstream end in the passing direction of the pressing area N and corresponding to the set value V. Incidentally, “a position corresponding to the set value V” means a position in which the pressure of the pressing area N becomes the maximum when the dynamic viscoelasticity of the toner becomes the set value V. Besides, “when the dynamic viscoelasticity of the toner becomes the set value V” does not mean that the dynamic viscoelasticity completely coincides with the set value V, but means that a minute error is allowable.

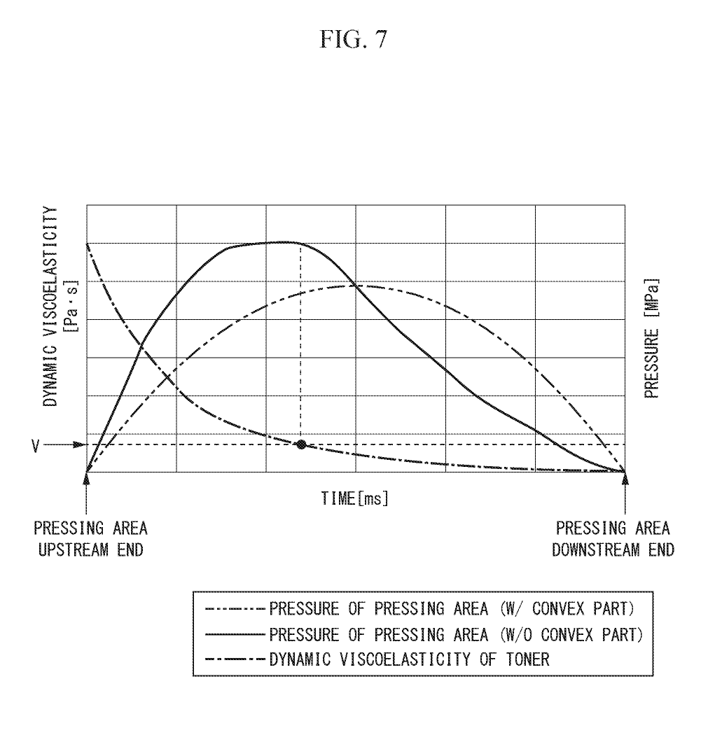

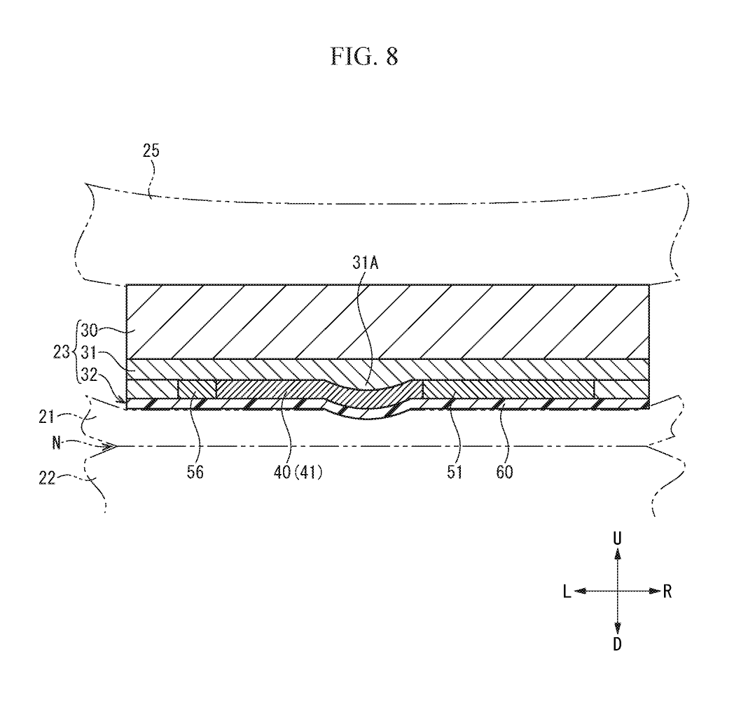

In the above-described fixing device 7 in accordance with the present embodiment, the convex part 31A that is formed on the heat insulation layer 31 protrudes the heating and contacting part 32, which causes the area with the maximum pressure in the pressing area N. According to this constitution, the convex part 31A that a portion of the heat insulation layer 31 is thickened can be formed at any position in the passing direction of the pressing area N using a film-forming technology such as the sputtering. This convex part 31A can be easily and precisely formed using the film-forming technology such as the sputtering. In consequence, the pressure of the pressing area N can be maximized at an appropriate position. For instance, when the set value V lies upstream from the center in the passing direction of the pressing area N as shown in FIG. 7, the convex part 31A can be formed on the heat insulation layer 31 so as to correspond to the set value V as shown in FIG. 8.

In the fixing device 7 in accordance with the present embodiment, the convex part 31A is formed in a section of the heat insulation layer 31 in which the storage elastic modulus G′ of the toner on the sheet S is equal to or less than 4200 Pa and the loss elastic modulus G′ is equal to or less than 60000 Pa while the sheet S passes through the pressing area N. According to this constitution, the toner with the dynamic viscoelasticity being sufficiently decreased can be passed through the area with the maximum pressure in the pressing area N. In consequent, the toner that melts in an extent in which a hot offset is not generated can be thermally fixed in an appropriate manner, which can make flat and smooth the surface of the toner after thermal fixing on the sheet S. As a result, the image having high glossiness can be obtained.

In the fixing device 7 in accordance with the present embodiment, the protruding amount H is set equal to or higher than 0.1 mm and equal to or less than 1.0 mm, and the upheaval width W2 is set equal to or higher than 15 percent and equal to or less than 20 percent of the pressurization width W1 of the pressing area N. According to this constitution, the convex part 31A in the pressing area N can press and heat the toner on the sheet S in an appropriate manner. As a result, execution of appropriate thermal fixing can be ensured and the image having excellent glossiness can be formed.

In the fixing device 7 in accordance with the present embodiment, since the heating parts 41 to 45 contact via the coat layer 60 to the inner surface of the fixing belt 21, smooth rotation of the fixing belt 21 can be ensured. Furthermore, the heating parts 41 to 45 can directly heat a portion of the fixing belt 21 that is opposed to the pressing area N, which can reduce heat that is not used to heat the fixing belt 21 and radiates, and thus input electricity can be effectively utilized.

According to the present embodiment, the printer 1 (i.e., the image forming apparatus) that includes the above-described fixing device 7 is realized.

In the fixing device in accordance with the present embodiment, each of the heating parts 41 to 45 is configured with a plurality of the heating resistors 40. Nevertheless, the present disclosure is not limited to this constitution. For instance, each of the heating parts 41 to 45 may be configured with a single heating resistor 40 (not shown). With respect to the fixing device 7 in accordance with the present embodiment, the heating parts 41 to 45 correspond to three sizes of the sheet S. Nevertheless, the present disclosure is not limited to this constitution. It is preferable that the heating parts (the heating resistors 40) be formed so as to correspond at least two sizes of the sheet S. With respect to the fixing device 7 in accordance with the present embodiment, it is constituted that the sheet S passes through the center in the axial direction of the pressing area N. Alternatively, it may be constituted that the sheet S may pass through a position close to one side in the axial direction of the pressing area N.

In the fixing device 7 in accordance with the present embodiment, the pressing roller 22 is rotatively driven and the fixing belt 21 is rotated by following the pressing roller 22 (i.e., gives a driven rotation). Alternatively, the fixing belt 21 may be rotatively driven and the pressing roller 22 may be rotated by following the fixing belt 21 (i.e., may give a driven rotation).

In the fixing device 7 in accordance with the present embodiment, the pressing roller 22 is raised and lowered against (moved to a direction to approach or a direction to separate from) the fixing belt 21. Nevertheless, the present disclosure is not limited to this constitution. Alternatively, the fixing belt 21 may be moved to a direction to approach or a direction to separate from the pressing roller 22.

In the above description regarding the present embodiment, it is exemplified that the disclosure is applied to the monochrome printer 1. Alternatively, for instance, the disclosure may be applied to a color printer, a copying machine, a facsimile, or multifunction peripheral and so forth.

While the present disclosure has been described with reference to the particular illustrative embodiments, it is not to be restricted by the embodiments. It is to be appreciated that those skilled in the art can change or modify the embodiments without departing from the scope and spirit of the present disclosure.

1. A fixing device comprising:
a fixing member configured to heat toner on a medium with rotating around an axis thereof;
a pressing member configured to, with rotating around an axis thereof, form a pressing area with the fixing member and to press the toner on the medium passing through the pressing area; and
a heat source configured to be provided corresponding to the pressing area across the fixing member and to heat the fixing member,
wherein the heat source includes:
a heat insulation layer configured to be laminated on a base material and to have a convex part that protrudes toward the fixing member; and
a heating and contacting part configured to be laminated on the heat insulation layer that has the convex part and to contact to an inner surface of the fixing member so as to heat the fixing member, and
wherein the convex part protrudes the heating and contacting part laminated thereon toward the fixing member so as to maximize pressure in the pressing area.

2. The fixing device according to claim 1, wherein the convex part is formed in a section of the heat insulation layer in which a storage elastic modulus G′ of the toner on the medium is equal to or less than 4200 Pa and a loss elastic modulus G″ is equal to or less than 60000 Pa while the medium passes through the pressing area.

3. The fixing device according to claim 1,
wherein a protruding amount of the convex part is set to equal to or higher than 0.1 mm and equal to or less than 1.0 mm.

4. The fixing device according to claim 1,
wherein a length in a medium passing direction of the convex part is set equal to or higher than 15 percent and equal to or less than 20 percent of a length in the medium passing direction of the pressing area.

5. The fixing device according to claim 1,
wherein the base material is made of a material that has electrical insulating property,
wherein the heat insulation layer is formed on the base material, using a material that has electrical insulating property and low thermal conductivity, and
wherein the heating and contacting part includes:
heating parts configured to be formed on the heat insulation layer using a material that has electrical conductivity and to be heated by being fed with power;
electrode parts configured to be formed on the heat insulation layer using a material that has electrical conductivity and to be electrically connected to both sides in a medium passing direction of the heating parts; and
a coat layer configured to be formed using a material that has electrical insulating property and small sliding friction force against the fixing member, and to coat the heating parts and the electrode parts.

6. The fixing device according to claim 5,
wherein the heating parts are formed of plural heating resistors that are arranged in line in an axial direction.

7. The fixing device according to claim 6,
wherein each of the plural heating resistors is formed so as to be substantially rectangularly elongated in the medium passing direction.

8. The fixing device according to claim 6,
wherein the plural heating resistors are formed in substantially the same dimensions.

9. An image forming apparatus comprising the fixing device according to claim 1.
